(19) United States
(12) Patent Application Publication
(10) Pub. No.: US 2005/0198062 A1
(43) Pub. Date: Sep. 8, 2005

(54) Method and apparatus for accelerating data access operations in a database system

(76) Inventor: Richard B. Shapiro, Wayland, MA (US)

Correspondence Address: JOHN C. GORECKI, ESQ., 180 HEMLOCK HILL ROAD, CARLISLE, MA, 01741, US

(21) Appl. No.: 11/076,511

(22) Filed: Mar. 7, 2005

Related U.S. Application Data
(60) Provisional application No. 60/550,720, filed on Mar. 5, 2004.

(51) Int. Cl. G06F 17/00

(52) U.S. Cl. 707/102

(57) ABSTRACT

Data access operations in a database system may be accelerated by allowing the memory cache to be supplemented with a disk cache. The disk cache can store data that isn't able to fit in the memory cache and, since it doesn't contain the primary copy of the data for the database, may organize the data in such a way that the data is able to be streamed from the disks in response to data read operations. The reduced number of read data operations allows the data to be read from the disk cache faster than it could be served from the primary storage facilities, which might not allow the data to be organized in the same manner. The cache hit ratio may be increased by compressing data prior to storing it in the cache. Additionally, where a particular portion of data stored on the disk cache is being used heavily, that portion may be pulled into memory cache to accelerate access to that portion of data.

### CROSS-REFERENCE TO RELATED APPLICATIONS

This application is related to and claims priority to Provisional U.S. Patent Application No. 60/550,720, filed Mar. 5, 2004, the content of which is hereby incorporated herein by reference. This application is also related to U.S. patent entitled “Method And Apparatus For Accelerating Data Write Operations In A Database System,” filed on even date herewith, the content of which is also hereby incorporated by reference.

### BACKGROUND OF THE INVENTION

1. Field of the Invention

The present invention relates to database systems and, more particularly, to a method and apparatus for accelerating data access operations in a database system.

2. Description of the Related Art

A database is a collection of data that may be organized to enable the data to be retrieved, updated, and managed. Databases may include numerous types of data, such as textual information, numerical information, pictorial information, multimedia files, and other types of information. Databases are conventionally used to store data for many types of computer program applications, such as inventory systems, medical recordkeeping systems, financial recordkeeping systems, airline reservation systems, and countless other systems.

Databases have grown over the years so that presently it is not uncommon for a large commercial database, such as a database configured to hold telephony records, to contain billions of rows of data. Storage of a large database of this nature may require in excess of several terabytes of data storage resources.

Although databases may contain a considerable amount of information, often a considerable proportion of the data is relatively infrequently accessed. Since low latency storage such as Random Access Memory (RAM) arrays are fairly expensive, databases typically use relatively inexpensive data storage devices such as magnetic or optical disk drives to store the data in the database. For example, a network storage system having a large number of relatively small, inexpensive magnetic disk drives is often, used to store the database. The disk drives may be organized to allow multiple copies of the data to be stored at different locations, known as “mirroring,” so that failure of a given disk drive will not affect the integrity of the data.

While magnetic disk drives are able to provide very high levels of data storage at relatively low expense, the time required to access data non-sequentially from disk drives is relatively slow. The access time of a disk drive is a function of its physical characteristics. Specifically, disk drives generally have one or more disks which contain the data and are designed to spin at a particular rate. A head floats over the surface of the disk as it spins to read the data off the disk. Since the data is written on tracks that span the entire surface of the disk, and the head can only read one data track at a time, the head is required to move radially between the center and the outer edge of the disk to access to a particular piece of data on the disk. During a disk access operation, the head will thus move radially to locate the correct track or band on the disk and then the data will be read at that circumferal position once the disk has spun the proper angular amount to place the data under the head.

Standard disk drives generally have a spin rate of between 10000 revolutions per minute (rpm) and 15000 rpm. At this rate, the disk will complete a revolution every 0.006 or 0.004 seconds respectively. Assuming that it will take the disk on average a half revolution to place randomly accessed data under the head, the fastest average data access times could be expected to be between about two to three milliseconds. The amount of time it takes a disk to spin to the correct position to allow the data on the disk to be read is known as rotational latency. The rotational latency of the disk does not account for the time it takes to move the head to the proper radial position relative to the disk, which is referred to as seek time. Seek times of 3.5 to 6.0 ms are typical for high performance magnetic disk drives. High-end network storage systems that have been developed to store terabytes of data may use many, e.g. one hundred, magnetic disk drives configured in this manner and, accordingly, exhibit similar access speeds. One example of such a high-end network storage system is offered under the name Symmetrix™ by EMC corporation™.

The amount of time it takes to retrieve data from the disk drives during read operations plays an increasingly important role in determining how fast the database may serve data in response to a request. As processor speeds have increased, a computer system's ability to process data may outstrip its ability to receive the data so that a given database system may spend more time retrieving data than actually processing the data.

Rotational latency and seek times also impact the rate at which data may be written to the database, since write operations also require the disk drive head to be moved to the correct track and for the disk to spin to the correct position. Additionally, changing a particular piece of information may require multiple write operations on the database. For example, assume that a database contains information such that a given row of information in the database contains entries for approximately fifty different fields. An example of this may be a bank record having fields for the account holder's name, social security number, home address, zip code, telephone number, etc. Each of these fields may be indexed to enable a search to be performed more quickly on that field. Each index is generally stored as a separate block or series of blocks of data in the database. Accordingly, changing one row of the database typically updates multiple indexes and thus requires a read and write operation for each index associated with that row. These read and write operations often result in slow execution of the database application.

Since magnetic disk drives rely on moving parts to provide access to data, the data access and data write speeds achievable using magnetic disk drives is physically limited. Accordingly, to enable database operations to be accelerated, it has become common to use a cache of memory such as RAM to store the most recently requested data. Since it is possible to read data out of RAM much faster than the same data may be read from a disk drive, the use of a RAM cache may significantly improve the performance of the database.

A RAM cache will accelerate database performance only to the extent the sought data is present in the cache. If the cache doesn't contain the data, the data must be read from the disk drives with the attendant access latency discussed above. Since the amount of performance improvement depends on the number of reads that are able to be serviced from the cache, it is common to try to optimize performance of a database by maximizing the cache hit ratio.

One way to increase the cache hit ratio is to increase the size of the cache. Unfortunately, this solution is fairly expensive since RAM is relatively expensive when compared to other storage facilities such as disk drives. Accordingly, it would be advantages to provide a method and apparatus for accelerating data access operations in a database system.

### SUMMARY OF THE INVENTION

According to an embodiment of the invention, a method and apparatus for accelerating data access operations in a database system is provided by allowing the memory cache to be supplemented with disk cache. The disk cache may be configured to store data that isn't able to fit in the memory cache in such a way that the data is able to be efficiently streamed from the disks in the disk cache in response to data read operations.

According to an embodiment of the invention, as data is read from or written to the relational database stored in a network storage system, a copy of portions of the data may be stored in a database intelligent cache (DBIC) having both a memory cache and a disk cache. Initially, the data is placed in the memory cache. Periodically, the data is moved from the memory cache to the disk cache and organized such that it can be read quickly from the disk cache. By organizing the data in a more optimal fashion in the disk cache, the number of disk access operations may be reduced to cause a greater volume of data to be streamed at disk read rates rather than requiring the data to be accessed from a variety of places on the disk. By allowing a duplicate copy of a portion of the database to be implemented in this manner in the disk cache, the underlying order and integrity of the database on the network storage system need not be altered. However, the duplicate copy of the data in the disk cache may be reordered to make it more likely to be able to read at disk streaming rates and, hence, to make the data more quickly accessible during read operations. In this manner, access latency in the database system may be reduced by reducing the number of seek operations required to be performed to access a given volume of data.

Numerous additional techniques may be used as well to increase the cache hit ratio to further improve performance of the database system. According to an embodiment of the invention, an improved compression technique is used to compress larger blocks of data and to separate the compression dictionaries from the compressed blocks of data. According to another embodiment, portions of data from the disk cache may be pre-fetched into memory when the history of recent accesses show that a particular table, index, or other portion of the data on the disk cache, is being more frequently accessed. By pre-fetching a table, an index, or another portion of data from the disk cache to the memory cache, the prefetched portion of data may be made available to improve the cache hit ratio and, hence, the database performance.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of a storage network including a DataBase Intelligent Cache (DBIC) according to an embodiment of the invention;

FIG. 2 is a functional block diagram illustrating the flow of data in an example network during execution of a write command according to an embodiment of the invention;

FIG. 3 is a functional block diagram illustrating the flow of data in an example network during execution of a read command according to an embodiment of the invention;

FIG. 4 is a functional block diagram of a database intelligent cache system according to an embodiment of the invention;

FIG. 5 is a functional block diagram illustrating an example data structure that may be used to implement the cache tables according to an embodiment of the invention;

FIG. 6 is a functional block diagram of a table block that may be stored in a database system;

FIG. 7 is a functional block diagram of an index block that may be stored in a database system; and

FIG. 8 is a functional block diagram of a block of data including a header portion to be stored in the memory cache or fast disk cache according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

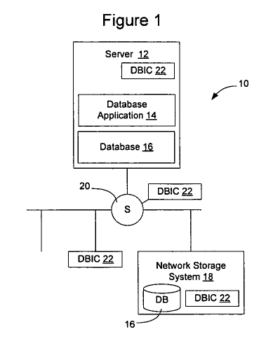

FIG. 1 illustrates one example of a storage network 10 having a server 12 running a database application 14 that is configured to access a database 16 maintained in a network storage system 18. Access to the database 16 may occur over the storage network 10, which may include direct connections between the server 12 and network storage system 18, or may include one or more network elements such as switch 20 intermediate the server 12 and network storage system 18. A network element, as that term is used herein, will be used to refer devices such as routers, switches, hubs, proxies, and other devices coupled to and configured to pass data to one another.

The data may be transported between the server 12 and network storage system 18 using any desired combination of networking protocols. For example, the storage network may be implemented as a Fibre Channel or an Ethernet physical layer, and may be configured as a point-to-point network, as an arbitrated loop, as a switched network, or in another desired topography. Generally, the Fibre Channel protocol is used to transport SCSI traffic between the server 12 and the network storage system 18 by serializing the SCSI commands into Fibre Channel frames, although Fibre Channel may be used to support protocols other than SCSI as well. The invention is not limited to use in connection with any particular networking protocols, or to a particular network topography chosen to implement the storage network. For example, the storage network may be implemented to incorporate network attached storage (NAS), a centralized channel attached storage network, or distributed channel attached storage. The network illustrated in FIG. 1 is merely illustrated to provide context for a possible environment in which operation of embodiments of the invention may be explained, and is not intended to limit applicability of these embodiments to other network configurations or in connection with other non-network based implementations.

In the example shown in FIG. 1, the server may be a conventionally available server configured to run a relational database stored on the network storage system. The server and its database may be accessed by database applications 14 running on the server 12 or other servers (not shown). One or more terminals or personal computer stations (not shown) may be provided to allow users to obtain access to the database via the application. The network storage system 18 may be a storage system such as the Symmetrix™ network storage system available from EMC™, although the invention is not limited in this manner as many different network storage systems may be used. The network storage system is configured to provide a centralized pool of disk storage for the servers on the network and to provide primary storage facilities for the database. Since the particular network storage system chosen by a datacenter manager is not particularly relevant to understanding operation of embodiments of the invention, additional discussion of network storage systems will be omitted. Any commercially available network storage system, accordingly, may be used.

As shown in FIG. 1, according to an embodiment of the invention, a DataBase Intelligent Cache (DBIC) 22 may be deployed at one or more locations on the network to accelerate data access and write operations on the database. The DBIC 22 in this embodiment is configured to improve performance of the network storage system 18 by providing a memory cache that may be used to service read requests, and a disk cache that may be organized to provide fast access to data in the event that the requested data is not found in the memory cache. Additionally, according to another embodiment of the invention, the DBIC may enable write operations to be performed more efficiently in order to reduce the likelihood that a write operation will delay the DBIC from servicing a pending read operation, thereby accelerating the execution of the read operations.

The DBIC 22 may be implemented as part of the server 12, for example as a card that plugs into the server such as a PCI card, to make the DBIC appear as a storage unit to the server. Alternatively, the DBIC 22 may be embedded in the network storage system 18, to allow the DBIC to increase the performance of the network storage system 18 without requiring modification of the network or server environments. In this instance the DBIC may be configured to be added to a conventional network storage system 18 such as the Symmetrix™ system mentioned above. Alternatively, in this instance, the DBIC 22 may be configured to act as a storage system itself rather than as a cache, in which case it will be configured with permanent storage as well as temporary caching storage.

The DBIC 22 also may be associated with the switch 20, either as part of the switch 20 or as an adjunct to the switch 20, to allow the DBIC to communicate directly with the server 12. In this embodiment, the DBIC may be configured to implement a more efficient protocol, such as Remote Direct Memory Access (RDMA), to communicate with the server, and translate the commands received from the server into commands commonly used on a storage area network such as iSCSI or Fibre Channel.

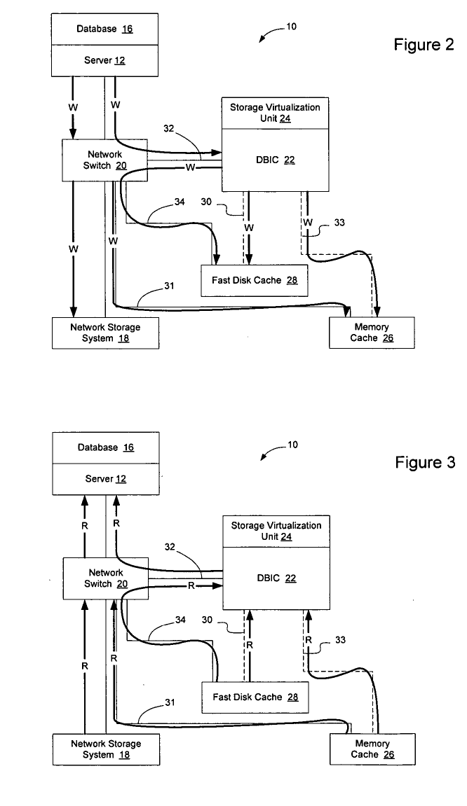

Additionally, the DBIC 22 may be associated with another network appliance, such as a network layer storage virtualization unit 24 (See FIGS. 2 and 3) configured to enable storage resources to be abstracted to an alternative set of addresses. Storage virtualization enables the applications to address storage resources without requiring the applications to know the details associated with the physical details of various disks, tapes, and other storage devices that may be used to implement the storage on the network. By associating the DBIC 22 with a network layer storage virtualization unit 24, the DBIC may be able to be treated as an existing, known storage resource. This, in turn, allows the DBIC to be hidden from the other components of the storage network 10 such as the databases 16, switches 20, servers 12, and network storage systems 18 operating on the network and, hence, to cause the DBIC operation to be transparent to these components. Where network layer storage virtualization is implemented, the DBIC operation may be hidden when implemented in stand-alone mode as well, however, and the invention is thus not limited to an embodiment in which the DBIC is incorporated as an aspect of the network layer storage virtualization unit 24. The concepts set forth herein relating to operation of the DBIC may apply regardless of where the DBIC is deployed on the network and, accordingly, the invention is not limited to a particular implementation or to deployment scenario.

FIGS. 2 and 3 illustrate examples of how write and read operations may be implemented using a DBIC 22 attached to the network switch 20. As discussed above, the DBIC may be attached to other entities in the storage network 10 as well and the invention is not limited to the example illustrated in FIGS. 2 and 3. In the embodiment illustrated in FIGS. 2 and 3, the DBIC is attached to a network layer storage virtualization unit 24 configured to allow the storage resources to be abstracted at the network level. Virtualization may occur at another level as well and the invention is not limited to an implementation that abstracts storage at the network level.

As shown in FIG. 2, when the switch 20 receives a write instruction, the switch will act as a mirror to cause write commands from the server to be sent to both the network storage system 18 and the DBIC 22. The storage virtualization unit 24 on the DBIC 22 may be configured to control operation of the switch or, alternatively, another component in the storage network 10 such as the DBIC 22 may be configured to control the switch 20. Enabling the write commands to be sent to both the network storage system 18 and the DBIC 22 allows the network storage system 18 to keep an accurate data set of the database 16, while enabling the DBIC 22 to maintain an up-to-date version of its portion of the data as well. Upon receipt of a write instruction originating from the database 16 and issued from the server 12, the network switch 20 will forward the write instruction to the network storage system 18. The network storage system 18, upon receipt of the write instruction, will update the appropriate stored data using the addresses and blocks of data provided by the write command.

To allow the DBIC 22 to service read commands, the write commands are passed to the DBIC 22 as well. As discussed in greater detail below, when the DBIC 22 receives a write command it handles the write command in such a manner as to reduce congestion between the write commands and any pending read commands to thereby accelerate the execution of read operations on the DBIC. Databases typically waits for an acknowledgement of certain write commands and so any delay in write acknowledgement from the DBIC 22 would slow database access operations. Accordingly, the DBIC 22 may cause the write command to be written to either a memory cache 26, a recently written blocks cache, or a fast disk cache 28, as discussed in greater detail below. By causing the write operations to be performed in an accelerated fashion using a fast write operation, an acknowledgment may be issued faster to thereby unlock the database to enable continued execution of read and write operations.

As shown in FIG. 2, the data associated with the write instruction may be sent from the DBIC 22 to the fast disk cache 28 over a dedicated link 30 or, alternatively, may be passed over links 32, 34, associated with the switch 20 and the storage network 10. Similarly, the data may be sent from the DBIC directly to the memory cache 26 over link 33 or, alternatively, may be passed through over links 32, 31, associated with the switch 20 and the storage network 10. Using the direct connection links, 30 and 33, utilizes DBIC resources to service write commands. Utilizing the indirect routes through the switch 20, links 32, 34 or 32, 31, allows the fast transport services of the switch 20 to be used to interconnect the DBIC 22 with the fast disk cache 28 or the memory cache 26, respectively.

Mapping of write commands (and read commands) between the components of the storage network 10 may be performed by causing an appropriate lookup to occur on the Cache Allocation Tables (CAT) 36 (discussed below) which are maintained by the DBIC to keep track of the location of data stored by the DBIC. The CAT lookup may be performed at the switch 20 by providing the switch with a copy of the CAT 20 or by causing the switch 20 to issue a request for a CAT lookup to the DBIC 22. Alternatively, the write (or read commands) may be passed directly to the memory cache 26 and/or write cache 28 which can then perform a CAT lookup operation (if provided with a copy of the CAT tables) or the caches 26, 28 may issue a CAT lookup request to the DBIC 22. In any of these instances, mapping of write commands may be performed directly to the caches 26, 28, without causing the data to be passed through the DBIC 22. Combinations of these several methods may be used as well and the invention is not limited to a particular manner of mapping the write and read operations to the caches. The process with which the DBIC 22 may accelerate data write operations will be discussed in greater detail below.

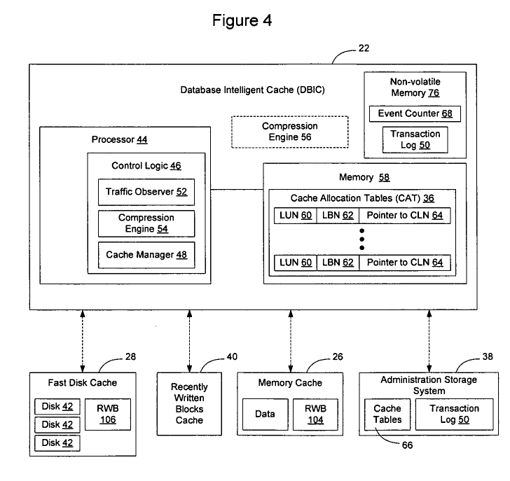

FIG. 3 illustrates the flow which occurs when the server 12 executes a read command on the database 16. As shown in FIG. 3, upon receipt of a read command, the read command will be forwarded to the DBIC 22. The DBIC 22, in this embodiment, is responsible in the first instance for servicing all read commands sent to the database 16. This provides the DBIC with an opportunity to accelerate responses to read commands. To serve a read command, the DBIC will access its cache allocation tables (CAT) 36 (see FIG. 4) to determine whether it has a copy of the data requested by the read command and, if it does, will read the data out of its attached memory cache or fast disk cache.

If the DBIC 22 does not have a copy of the requested data, a not-in-cache response will be returned from a search of the CAT 36, which will cause the DBIC to send an exception to the switch to cause the switch to forward the read request to the network storage system 18 to allow the read request to be serviced by the network storage system 18. Similarly, the switch 20 may automatically cause an exception to occur if the DBIC 22 doesn't respond within a particular period of time, or alternatively, it may have access to its own set of local tables (not shown) indicating that the data is not in the DBIC 22 and must be fetched from the network storage system 18. In this manner, the failure of the DBIC 22 will not prevent the processing of data, yet when operational the DBIC 22 will be able to service read requests in lieu of normal service by the network storage system. This is advantageous because, on average, the DBIC 22 may be expected to deliver data faster than the network storage system 18. Additionally, by causing the DBIC 22 to service read requests, fewer read requests will need to be serviced by the network storage system 18 thereby allowing the network storage system 18 to focus its resources on other tasks including the execution of write commands issued by the database application.

In another embodiment of the invention, the read commands may be sent alternately between the DBIC 22 and the network storage system 18 to allow a balancing of loads between the two delivery systems. The switch 20 in this instance may then serve the first response to the server 12 from the network storage system 18, the second response from the DBIC 22, the third from the network storage system 18 and so on. This balancing of loads may be dynamically adjusted, for example by the storage virtualization unit 24, by examining the response times received from the network storage system 18 and utilization metrics from the DBIC 22.

Where the network storage system 18 executes a read command, the data returned by the network storage system 18 may be sent to the DBIC 22 and served from the DBIC 22 to the server 12. Alternatively, the switch 20 may forward the data directly to the server 12 and send a copy of the data to the DBIC 22 so that the DBIC 22 is able to maintain an up-to-date copy of the data fur use in connection with serving subsequent data read commands.

When the DBIC 22 has a copy of the requested data, the requested data is served from either the fast disk cache 28 or the memory cache 26. If the data is available in the memory cache 26, or in both the memory cache 26 and the fast disk cache 28 , the data will be served from the memory cache 26 to the server 12. If the data is available only in the fast disk cache 26, the data will be served from the fast disk cache 26 to the server 12. The data may be served directly from either cache 26, 28 to the server via the switch or first may be passed to the DBIC and then served from the DBIC 22 to the server 12.

FIG. 4 illustrates an embodiment of a DataBase Intelligent Cache (DBIC) 22 that may be used in one or more of the locations identified in the storage network 10 shown in FIG. 1 or in another desired location or computer element. As shown in FIG. 4, and as discussed above, the DBIC 22 may be connected to one or more storage facilities, such as a fast disk cache 28, a memory cache 26, and optionally to additional storage resources such as an administration storage facility 28 and/or to a recently written blocks cache 40 that may be formed of solid state memory such as RAM, disk storage, or both.

The fast disk cache 28 may be implemented as one or more magnetic or optical disk drives 42 configured to store data associated with the database 16 on behalf of the DBIC 22. The disk drives 42 may be standard disk drives, such as IDE, ATA, or SATA disk drives, or optionally may be higher performance disk drives such as SCSI or FC disk drives. The disk drives 42 will be used as a cache to store database data in a manner that is more optimized for retrieval given anticipated database access operations, to thereby accelerate database read operations vis-a-vis performing the same operations from the network storage system 18. Techniques for storing the data according to embodiments of the invention will be described in greater detail below.

The memory cache 26 may be implemented as an array of Random Access Memory (RAM) modules, solid state disks, or other components configured to provide high speed access to data on the system. The memory cache may be of any desired size, which may depend on the size of the database 16 being served by the DBIC 22, the performance requirements of the database application 14, and other performance factors. The size of the memory cache 26 may be adjusted depending on other factors as well and the invention is not limited by the particular methodology used to select the size of the memory cache 26.

The administrative storage system 38 may be an independent storage facility or may be formed as part of the fast disk cache 28 or the memory cache 26. When formed as an independent storage facility, it may be implemented using any available storage technology, such as one or more magnetic or optical disks, solid state disks, RAM memory modules, or a combination of these or other storage technologies. Preferably at least a portion of the storage used to implement the administrative storage system 38 is non-volatile storage, since the administrative storage system may be used to backup information important to operation of the DBIC 22 or to recovery of the DBIC upon failure. The invention is not limited to the manner in which the administrative storage system 38 is implemented in the DBIC, however.

The Recently Written Blocks (RWB) cache 40 may be an independent storage facility or also may be formed as part of the fast disk cache 28 or the memory cache 26. When formed as an independent storage facility, it may be implemented using a block of RAM configured to quickly implement write commands and one or more magnetic disks to which the recently written blocks may be moved for longer term storage. In this manner, a small portion of RAM may be provided to cache the recently written blocks as they first arrive at the DBIC, and then the blocks may be moved to disk storage until they are able to be integrated into the memory cache 26 or fast disk cache 28. The invention is not limited to the manner, however, as the RWB cache may be configured in a number of different manners.

The DBIC 22 includes a processor or processors 44 containing control logic 46 configured to implement a cache manager process 48 that is responsible for the overall operation of the DBIC. The cache manager 48 services read and write commands, controls which data is stored in the memory cache 26 and fast disk cache 28, controls which data is discarded from the memory cache 26 and fast disk cache 28 to make room for new entries, and organizes the placement of data stored in the fast disk cache 28 to allow that data to be able to be efficiently read from the fast disk cache 28. The cache manager 48 also manages the RWB cache 40 including the background task that is responsible for writing data from the RWB cache to the main data sections of the fast disk cache 28 and memory cache 26. In addition, the cache manager 48 manages the cache allocation tables (CATs) 36 including the occasional defragmentation of those tables, maintains a transaction log (50) of cache altering transactions (discussed below), and manages all aspects of recovery from system or power failure.

The DBIC 22 also includes the ability to compress data prior to causing the data to be stored in the memory cache 26, fast disk cache 28, or RWB 40, and the ability to decompress data prior to serving the data to the server 12. To support these compression/decompression operations, a compression engine process 54 may be implemented in the control logic 46 of processor 44, or alternatively an independent compression engine 56 may be provided to accelerate compression/decompression operations. Additional details related to compression and decompression are set forth in greater detail below.

The DBIC 22 may also be configured to implement a traffic observer process 52 configured to detect patterns in read and/or write operations and to provide information to the cache manager 48 associated with the patterns to allow the cache manager 48 to make better decisions as to which data should be discarded from the memory cache 26 and fast data cache 28, and which data should be pre-fetched from the fast data cache 28 to the memory cache 26. The traffic observer may support other operations as well, as described in greater detail below.

The DBIC also includes a memory 58 containing Cache Allocation Tables (CAT) 36 that allow the DBIC to map incoming requests for data to storage locations in the memory cache 26 or fast disk cache 28. Each read and write request passed to the database will identify the data using two values, a Logical Unit Number (LUN) 60 that identifies the storage volume where the data is stored to be stored, and a Logical Block Number (LBN) 62 which identifies where on the storage volume the data is stored or is to be stored. The LUN/LBN pair identifies, to the network storage system 18, which data is requested in the read instruction. Alternatively, the LUN/LBN combination may be mapped to a single identifier or address that may be an assigned number or a hash of the LUN and LBN numbers.

The cache allocation tables (CAT) 36 correlate the LUN 60 and the LBN 62 or other identifying information of the data in the network storage system with a pointer 64 to a Cache Location Number (CLN). The CLN is an internal reference to where in the DBIC the local copy of the data may be found. The CLN may contain a pointer to where the data is stored in the fast disk cache 28, or a pointer 64 to where the data is stored in the memory cache 26, or a pointer 64 to where the data is stored in the RWB cache 40. By using the LUN/LBN pair 60/62 to lookup the Cache Location Number (CLN) 64 in the CAT 36, the location of the desired data in the DBIC memory cache 26 or fast disk cache 28 may be ascertained. The cache manager 48 may also perform other operations on the CAT 36, such as the deletion of one or more entries for a particular LUN/LBN, and the addition of an entry for an LUN/LBN.

Since not all data may be contained in the DBIC caches 26, 28, the DBIC 22 may occasionally perform a search for a LUN/LBN and determine that the data is not in the memory cache 26 or fast disk cache 28. In this instance, the read request will need to be forwarded to the network storage system 18 and serviced there. To prevent cache misses from unduly delaying read requests, the cache manager 48 should be able to quickly search the CAT 36 for a given LUN/LBN pair, to allow the DBIC 22 to quickly determine whether the requested data is available. If the data is available, the cache manager 48 may then cause the DBIC to quickly deliver it, and if not, the cache manager 48 may cause the command to be passed quickly back to the network storage system 18 to allow the network storage system 18 to service the request.

In the example embodiment illustrated in FIG. 4, the LUN/LBN and pointers are illustrated as being organized in a standard index-fashion to allow the correlation between LUN/LBNs and CLNs to be visualized. In an actual implementation, the data structure selected to implement the cache tables 36 may be somewhat more complicated to allow the cache table searches to be accelerated relative to a standard index search. For example, the LBN and LUN may be hashed and a linked list may be used to provide a pointer to the RAM cache location. Alternatively, an in-memory tree structure, such as a multiple choice binary tree commonly referred to as a B-tree structure, may be used to implement the cache tables. Although an implementation using a B-tree will be explained, the invention is not limited in this regard as other available data structures and indexing techniques may be used as well.

B-trees are well defined data structures. Accordingly, an exhaustive description of B-tree data structures will not be provided. However, to facilitate a basic understanding of how B-trees work, a brief summary of basic B-tree structure will be provided. The invention is not limited to the details set forth in this brief summary.

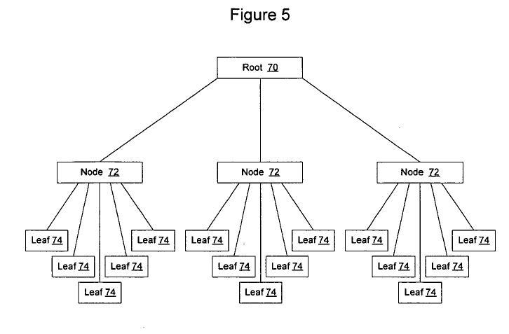

A graphical conceptual representation of a B-tree is illustrated in FIG. 5. As shown in FIG. 5, a B-tree generally includes a root node 70, a plurality of intermediate nodes 72, and leaf nodes 74 attached to the root 70 or intermediate nodes 72. Keys are used to locate data stored in the B-tree structure to locate nodes 72 and leaves 74. To allow the keys to be used to find a particular leaf 74 on the tree, the keys are stored in the B-tree in increasing order. Each key has an associated child that is the root of a B-tree containing all nodes with keys less than or equal to that key, but greater than the preceding key. Since each node tends to have a large branching factor (a large number of children) a B-tree structure tends to be a fairly efficient structure to search since relatively few nodes will need to be traversed to hone in on the correct leaf. In the illustrated example, a simple three level B-tree is illustrated. The invention is not limited in this manner as a B-tree may have any desired depth (number of levels of nodes) and any desired minimization factor (minimum number of children per node). Knowledge of the manner in which the keys are stored in the tree allows the location of a leaf associated with a key to be found very quickly.

Where the cache tables are to be implemented using a B-tree structure, the B-tree will carry keys and the leaves will carry the CLN information associated with the keys. Thus, the LUN/LBN must be converted to a key number to allow the LUN/LBN to be used to access the correct leaf in the tree. This may be accomplished in a number of ways. For example, a table of LUNs may be maintained with a unique number assigned to each LUN. This number may be concatenated with the LBN and the result used to point into the balanced B-tree. Alternatively, the LUN/LBN pair may be hashed to generate the key for accessing the relevant leaf of the B-tree. Numerous ways of generating a key may be implemented, and the invention is not limited to implementation of a particular technique. By using B-tree structures, relatively large cache tables may be searched efficiently so that access may be relatively fast as well.

Operation of the DBIC depends on the validity of information contained in the memory cache 26 and CAT 36. If the CAT 36 is corrupted and references incorrect areas of the memory cache or fast disk cache 28, execution of a read request via the DBIC 22 would cause incorrect data to be returned. Similarly, a loss of data from the memory cache 26, due to power or other failure, would result in an inability to use that data. Since the memory cache 26 and the CAT 36 take a long time to build, a loss of this data may cause a reduction in the DBIC's effectiveness and, therefore, database performance for a considerable period of time.

According to an embodiment of the invention, two backup systems are provided to help maintain the integrity of the memory cache 26 and CAT 36 in order to help the DBIC 22 recover from a failure or loss of data in the CAT 36. As shown in FIG. 4, the contents of the CAT 36 may occasionally be written out to an area 66 on the administration storage system 38 to allow the CAT 36 to be backed up and, hence, to allow the CAT 36 to be recovered in the event of a failure. The periodicity with which the CAT 36 may be backed up to the administration storage system 38 may be on the order of minutes or on the order of one or more hours, depending on the rate of change of information in the memory cache 26 and fast disk cache 28 and, hence, the rate or change of entries in the CAT 36. Where the data in the DBIC's caches 26, 28 do not change very often, and the CAT 36 is therefore relatively static, the inter-backup period may be relatively longer than when the CAT 36 is changing more frequently.

In addition to backing up the CAT 36 onto an area 66 of an independent storage facility such as administrative storage system 38, a transaction log 50 may also be maintained. The transaction log 50 in this context is a recordation of events that affect the content of the CAT 36. For example, when data is added to the memory cache 26 or disk cache 28, or when data is shifted between the caches or deleted from one of the caches, the CAT 36 will be updated to reflect this change. To ensure that all transactions are captured, each transaction that updates the CAT 36 is assigned an event count as provided by event counter 68. An event count is a counter set to zero when the system first becomes operational and is incremented each time a transaction is processed. The event counter may be stored in non-volatile memory to enable it to be preserved in the event of a power or other failure of the DBIC. The event count is never decremented and is implemented to have a sufficiently large word length, for example 128 bits, such that it never overflows. Whenever a CAT altering event occurs, the event counter 68 is incremented, the current counter value is associated with the event, and a log of the transaction is written to the transaction log 50.

Given the importance of maintaining a record of transactions that affect the CAT 36, a copy of the transaction log 50 may optionally be stored in the DBIC resident memory 58 or in a section of non-volatile memory 76 on the DBIC as well as on the administration storage system 38 to provide for redundant storage of the transaction log 50. If information in the CAT 36 is lost, the transaction log may be used to recreate changes to the CAT 36 to allow a new up-to-date CAT 36 to be created. The event count enables the recreation process to occur in order by allowing changes to the CAT 36 to be recreated in the order in which they original occurred, and also allows the cache manager to ensure that all events that have affected the content of the cache tables have been stored in the transaction log, and that none of the transactions have been inadvertently not stored in the transaction log or not accounted for in the cache table recreation process.

As described above, to prevent the transaction log 50 from being affected by a power failure or other failure condition, preferably at least one and possibly both copies of the transaction log 50 are maintained in non-volatile memory such as non-volatile memory 76. The invention is not limited in this manner, however, as the transaction log may also be maintained on one of the caches such as the memory cache 26 or the disk cache 28.

When the CAT 36 is written out to the administration storage system 38, the transaction log 50 may be reset to allow only subsequently received transactions to be maintained in the transaction log 50. Specifically, since the transaction log 50 records changes to the CAT 36 that have affected the content of the caches 26, 28, once a backup of the CAT 36 has been made, the transactions in the transaction log 50 may be considered obsolete and, hence, deleted.

The memory cache 26 contains a large array of fast memory such as RAM or solid state disk memory and is used to cache storage blocks. As discussed below, data blocks may be compressed prior to being stored in the memory cache to allow a greater number of blocks of data to be stored in the memory cache 26. Since the compressibility of the storage block will vary from block to block, the blocks of data may be expected to be of uneven size. To allow the blocks to be packed as tightly as possible, the CAT 36 allows any storage block to be mapped to any location in the memory cache 26. Thus, storage of blocks of data is not limited to modular preset areas of the memory cache 26 but rather may occur using variable sections of memory. Optionally, blocks of memory of varying modular size may be allocated to blocks that are to be written to the memory cache 26. For example, blocks having sizes of 0.5, 1.0, 1.5, 2.0, 2.5, 3.0, 3.5, and 4.0 may be allocated in the memory cache 26 when storing a compressed 4K byte block of data. By allowing different block sizes to be allocated depending on the achievable compression particular to that block, effective use of memory may be achieved despite the variability of compression efficiency for different blocks.

When blocks become invalidated (as discussed below in connection with the section on writing data instructions) or as blocks of data are kicked out of the memory cache 26 to make room for other more important data blocks, the memory cache 26 may become fragmented. To free up contiguous blocks of memory, the memory cache 26 may be defragmented periodically. This may be performed by repacking the blocks during periods of less frequent use or as a background task. As the memory cache 26 is repacked, the CAT 36 will be updated to cause the CAT 36 to contain updated pointers 64 to the new memory locations (CLNs) for those blocks, and the transaction log 50 will be updated to record the transactions associated with the defragmentation process. Similar defragmentation processes may be performed on the fast disk cache 28 as well.

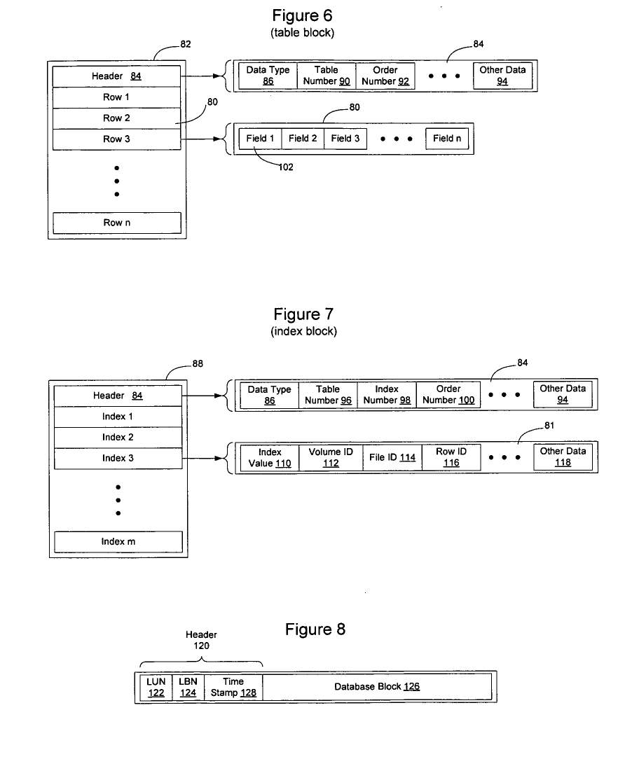

The fast disk cache 28 holds copies of cached database blocks, which allows the DBIC 22 to cache more blocks of data than would be possible using only the memory cache 26, by causing blocks or groups of blocks to be swapped from the fast disk cache 28 to the memory cache 26 when they are needed or anticipated to be needed to service a read command. Also, the fast disk cache 28 continues to hold data that would otherwise be lost in the event of a power failure. The fast disk cache 28 may thus operate to service cache misses in the memory cache 26 to thereby increase the effective size of the memory cache 26. To enable the DBIC 22 to read data blocks efficiently, space on the fast disk cache 28 is divided into relatively large contiguous sections. Database blocks are sorted by table and index ID found in the headers 80 (FIGS. 6 and 7) or in another manner predicted to allow contiguous reads of such blocks to be performed and placed together in a section or number of sections on the fast disk cache 28. By placing entire indexes and data tables in a contiguous section on the disk, it is possible to read an entire index, or table, or a portion of the blocks associated with a given index or table, at disk streaming data rates rather than at individual disk read rates.

Where database operations such as index and table scans are likely to require portions of an index or table to be accessed repeatedly, organizing the data sequentially into contiguous sections allows sequential read operations to occur from the disk 42. This can significantly decrease the read time associated with such database operations.

As shown in FIG. 4, the DBIC 22 may be provided with a traffic observer process 52 configured to compile information about access patterns for one or more indexes associated with the database and/or to compile information about patterns with which table data is accessed. For example, if an index or table is experiencing frequent access, the traffic observer 52 may issue an instruction to cause the cache manager 48 to load all or a large portion of the index or table data into the memory cache 26. In this context, having the data organized on the fast disk cache may allow the data to be swapped into memory cache 26 at the disk streaming rate. The effect of this operation is to pre-fetch data into the memory cache 26 that is likely to be needed if the pattern observed by the traffic observer 52 continues.

Conversely, if a portion of the data associated with a particular index or table in the memory cache 26 is only infrequently being accessed, it may be removed from the memory cache 26 to make room for other data. To make room for prefetched data, a table or index that has not experienced high access rates for a longer period of time can be displaced or victimized from the memory cache 26. Optionally, the displaced data may be moved to the fast disk cache 28, although in other embodiments the displaced data may simply be deleted.

The traffic observer 52 keeps statistics on access for each table and index in the database. These statistics include the level of traffic, the length of time during which a burst of activity may take place, and the penalties associated with RAM cache misses. At the same time, the cache manager 48 assigns priority levels to each table and index. When the traffic observer 52 detects recent activity for a particular table or index, it passes the information to the cache manager, which weights the observed patterns with the index/table priority levels. If an index or table has a high priority level (i.e. it was more heavily accessed in the past), the cache manager will more aggressively pre-fetch it from the fast disk cache.

The traffic observer 52 may track blocks of data using an array of counters which may be incremented each time a block is accessed. The traffic observer may threshold the blocks to provide the cache manager with information as to which blocks have most recently been used. Additionally, the traffic observer 52 may be configured to notice patterns of accesses and use a database of historical traffic patterns to anticipate which blocks are likely to be accessed in subsequent access operations. Additionally, the traffic observer may monitor access times for particular blocks of data, compare the access times with access frequency, and try to minimize total access time required of the system. The traffic observer 52 may operate in multiple ways to obtain information regarding block access information and may process the information in many ways to provide the cache manager 48 with information to enable the cache manager 48 to make a determination as to which blocks should be maintained in memory cache 26, which should be maintained in disk cache 28, and which should not be maintained in either cache.

Relational databases, depending on the operation being performed, sometimes read indexes randomly and at other times read an entire index in an operation called an index scan. According to an embodiment of the invention, a differentiation may be made in the traffic observer 52 between those indexes or tables that are most often read randomly and those that are most often read fully. Specifically, indexes and tables that are read randomly require multiple disk seek operations to obtain portions of data, whereas data that is frequently read in its entirety may be accessed via a single seek operation and then streamed from the disk at the higher disk streaming rates. Thus, according to an embodiment of the invention, the traffic observer 52 may differentiate between indexes or tables that are read randomly and preferentially retain those relatively frequently accessed indexes or tables that are more randomly read over other similarly frequently accessed data blocks that are more sequentially read.

By preferentially retaining randomly accessed blocks of data in the memory cache 26, fast access to that data may be obtained from the memory cache. Additionally, by preferentially storing data blocks that are more often sequentially accessed in the fast disk cache, access to that type of data may be obtained by using a single seek operation and then streaming the required data from the fast disk cache 28. Thus, the cache allocation algorithm may be biased against holding sequentially scanned indexes because they can be quickly prefetched from their contiguous or mostly contiguous allocations on the disks 42 of the fast disk cache 28 and the memory cache may thereby be reserved for other data that would be harder to retrieve from the disk cache.

Index blocks may receive more frequent reads than other types of data blocks in the index. For example, assume that a department store chain has a group of branch offices that are required to update inventory and sales information in a central database once per day. Each update will affect the tables and, for each field that is indexed, the updates will also affect the index tables. Thus, the index blocks may be updated more frequently than other types of data.

Since indexes are more frequently used, the indexes may be stored in a designated area of the fast disk cache 28. For example, all of the indexes may be stored together, and each index may be allocated a relatively large portion of the disk space allocated to index storage. By storing all of the indexes in the same area of the disk, index access operations may be performed on multiple indexes while minimizing movement of the armature holding the disk drive head, to thereby accelerate write and read operations on the indexes. By allocating relatively large portions of the disk to each index, each index is allowed to grow natively without requiring redistribution of the indexes and without requiring a given index to be split between two or more non-contiguous disk areas. Maintaining the indexes in the fast disk cache 28 in a contiguous fashion allows the index to be streamed from the disk when it is necessary to load the disk into memory cache 26 to thereby accelerate the process of moving or copying the index between the fast disk cache 28 and memory cache 26. Similarly, a write operation which may occur to move the index from memory cache 26 to fast disk cache 28 may occur at data streaming rates.

Compression

In order to increase the effective size of the memory cache 26, the data may be compressed before being stored in the caches. While compression may increase the capacity of the fast disk cache 28 and the memory cache 26, if the processing required to decompress the data prior to delivery to the server is too great, delivery of the data will be slowed down, thereby reducing the effectiveness of the DBIC 22. As shown in FIG. 4, the control logic 46 operating on processor 44 may implement a compression engine 54 to enable the DBIC 22 to compress and decompress data. Additionally, or alternatively, the DBIC 22 may include a compression/decompression engine 56, such as a separate processor or hardware accelerator, configured to perform compression and decompression operations independent of the processor running the cache manager 48. Although an embodiment will be described in which compression is used to increase the storage capacity of one or more of the caches, the invention is not limited in this manner as the data may be stored in uncompressed format as well.

As mentioned above, compression and decompression may be handled by the DBIC processor 44 or may be offloaded to an independent compression engine 56. Standard compression techniques may be implemented and the invention is not limited to any particular compression technology. However, according to an embodiment of the invention, knowledge of the binary format of the database may be used to improve the compression process, for example by selectively deciding which blocks should be compressed and which should be stored in native format. Specifically, database blocks generally are grouped into two different types of blocks, index blocks and table blocks.

FIGS. 6 and 7 illustrate graphically a simplified representation of the structure of each of these types of blocks of data. As shown in FIG. 6, a table block 82 contains a header 84 containing identification information including a data type field 86 identifying the block as a table block. The header will also include a table number 90, an order number 92, and various other data of use to the database system 94. Similarly, an index bloc 88 will also contain a header 84 containing a data type field identifying the block as an index block, a table number 96, an index number 98, and an order number 100. The header may also include other information of interest primarily to the database system. Using the data type field of the header, the cache manager 48 may identify blocks as either index blocks or table blocks and how they are used by the database.

The binary blocks of data received by the DBIC may be identified using the header information; these headers are commonly provided by most high performance databases, however not all of the information shown in FIGS. 6 and 7 may available. The headers indicate whether the incoming block is an index or a table block, and may provide other identifying information such as a table number 90, 96, index number 98, and order number 92, 100. This information may be used to map blocks in the fast disk cache allowing data blocks of the same index or table to be ordered contiguously on the disk. Where present, the order number may also be used to allow the blocks to be arranged or partially arranged by order number. As discussed above, the contiguity of the data may be used to allow the data to be read at faster disk streaming rates when the data set is required to be read. Additionally, remapping the blocks to a contiguous portion of the disk allows the indexes to be essentially defragmented on a virtual basis, which thereby reduces the need to have a database administrator manually defragment a database's indexes.

After the header 84, the table block 82 contains one or more rows of data 80, 81. The data may be organized into fields, which may or may not be indexed depending on the way in which the database administrator has decided to configure the database. When a field is indexed, an index file (a portion of which may be contained in index block 88) is created to allow data in that field to more efficiently searched. Since index blocks are more frequently accessed by many database applications, and because (as discussed below) indexes may be more highly compressible than table blocks, the DBIC 22 may preferentially select to store index blocks 88 in the memory cache 26 over other table blocks 82.

As shown in FIGS. 6 and 7, both table blocks (FIG. 6) and index blocks (FIG. 7) contain header information (84) identifying the block and indicating whether the block is an index block 82 or a table block 88. Knowledge of the type of block, according to an embodiment of the invention, may be used to determine which blocks should be compressed. Particularly, index blocks 88 may be expected to be more highly compressible than table blocks 82, since much of the data in the index may be similar and, additionally, it may be expected to be ordered. Accordingly, the DBIC 22 may selectively compress blocks of data by discriminating between index blocks and table blocks. Alternatively, the DBIC 22 may compress all blocks and determine a compression factor for the blocks to identify those blocks that are more highly compressible. Where the blocks are more highly compressible, the reduced volume required to store the block in the memory cache 26 may outweigh the performance disadvantages associated with requiring the block to be decompressed before it can be served in response to a read request. A thresholding operation may thus be performed on compressed blocks to cause those blocks that are able to be compressed effectively to be stored in compressed format and causing other less compressible blocks to be stored in an uncompressed format.

Many different compression techniques may be employed. To help understand why index blocks may be more compressible than table blocks, a basic compression explanation will be provided. The invention is not limited to an implementation that operates in accordance with this high-level description.

Generally, compression may be accomplished by causing a process to sort through the data to look for repeating patterns and to then replace those patterns with a pointer to a compression dictionary of commonly found patterns. For example, assume that the following data was contained in a database:

| Name | State | Citizenship |
|---|---|---|
| Gord | Massachusetts | USA |
| Gorel | Massachusetts | USA |
| Goren | Massachusetts | USA |

A compression algorithm could replace the string “Gor” with “1”, the string “Massachusetts” with “2” and the string USA with “3”. A compression dictionary containing entries 1=Gor, 2=Massachusetts, and 3=USA could then be created, and the data compressed to look like this:

| Name | State | Citizenship |
|---|---|---|
| 1d | 2 | 3 |
| 1el | 2 | 3 |
| 1en | 2 | 3 |

As shown in this example, the frequency with which a particular term appears affects the compressibility of the data. Since indexes tend to contain very similar data for many of the entries, index blocks tend to be very compressible. For example, as shown in FIG. 7, a row of an index file 80 may contain an index value 110, a file name 112, a volume number 114, a row ID 116, and various other data. Many of these fields may be expected to contain the same or similar information. For example, a given table block may contain multiple rows of data that are identified and sorted together in the same index. In this instance, the file name and volume number may be expected to be similar. Thus, index blocks may be particularly amenable to compression.

Accordingly, the header information associated with the blocks may selectively be used to determine which blocks are to be compressed prior to being stored by causing index blocks 88 to be preferentially compressed over data blocks 82. In this embodiment, knowledge of the binary format of the database blocks was used to improve compression. For example, index blocks are parsed to isolate Row IDs, which are not compressible other than to eliminate leading 0's and redundant information such as file identifiers, and the remaining index data may be compressed because it is generally fairly ordered.

In addition to selectively performing compression on incoming blocks, compression may also be performed on a block size larger than the normal database block size to allow a greater degree of compression to be achieved. A larger block size allows the same dictionary to be used for a greater quantity of data to thereby reduce the overhead associated with associating the dictionary with the compressed data. Specifically, since the size of the dictionary in some cases may not change significantly if the dictionary is used to compress two blocks versus one block, the per-block overhead for storage of the dictionary may be comparatively reduced as the block size is increased. However, using normal compression methods, the use of a larger block size has a disadvantage in that the larger block size may degrade the cache hit rate because smaller sections of those blocks may be infrequently used. Also, the decompression time is longer because all of the data in the larger block, not just the required data, must be decompressed with some decompression techniques.

Although compressing a larger block of data is often slower than compressing a smaller block of data, this disadvantage may be mitigated by having the data contiguously placed in fast disk cache 28 or, in the case that the data is in the memory cache 26, due to the relatively fast access time. Additionally, by achieving a higher compression factor, the data will take up less room in the memory cache 26, thereby freeing up room in the memory cache 26 that may be used to store additional data to improve the hit rate of the memory cache 26.

Another technique that may be used to obtain greater compression is to separate the compression dictionary from the data block to improve compression efficiency. As discussed above, when data is compressed, a dictionary will be created correlating the compressed portions with the replaced values. Generally, and conventionally, the compression dictionary is included in the compressed block of data so that the data block may be decompressed. According to an embodiment of the invention, the compression dictionary may be separated from the compressed data, so that it may be used to decompress each of the individual blocks that was encoded using the common compression dictionary. Alternatively, two levels of compression dictionaries may be used—one common compression dictionary that is used for a set of data blocks and a second compression dictionary that may be used to compress the particular block. While the use of two compression dictionaries may require two decompression operations, the ability to decompress a portion of the larger compressed group of blocks may justify the use of the increased complexity of the decompression process.

Alternatively, according to another embodiment of the invention, a compression dictionary may be created for the entirety of an index or table. This may work particularly well when the cardinality of an index is not high—i.e. the number of related occurrences between entities in the database is relatively low. According to an embodiment of the invention, the cardinality of the index or table may be measured and a result of the measurement may be used to determine whether a compression dictionary should be created for the entirety of the index or table. A decision may then be made to always keep the dictionary in the cache or, alternatively, the dictionary may be stored in a cache associated with the compression/decompression engine. Numerous other compression techniques may be used as well and the invention is not limited to the use of one or more of the compression techniques described herein.

Write Back Cache

When blocks of data are written by the server 12, the write command is forwarded to both the network storage system 18 and to the DBIC 22. Forwarding the write command to the network storage system 18 allows an up-to-date copy of the data to be maintained in a normal fashion at the network storage system 18 so that the integrity of the database 16 may be ensured regardless of operation of the DBIC 22.

In addition, since the DBIC 22 is primarily responsible for handling read commands, to prevent the DBIC 22 from serving stale data, the write commands are also passed to the DBIC 22. To prevent the write commands from interfering with read commands, according to an embodiment of the invention, write commands may be written to an independent recently written blocks (RWB) cache 40 or to a dedicated portion of the memory cache 26 or streamed to a contiguous portion of the fast data cache 28 to allow the execution of write commands to be expedited (or segregated from read commands) and therefore to allow a larger portion of the DBIC resources to continue to be used to service read commands.

Write commands may consume a fair amount of DBIC resources, for example, where the memory cache 26 is tightly packed, an updated block of data may not fit into the portion of memory cache 26 that had been allocated to storage of the original block of data, since a write command may change a portion of the original data or may add new data to the data block. Attempting to place the new block to the previous location in that instance would require other blocks to be shifted. Additionally, where the original block is stored on the fast data cache 28, writing a block to the disk 42 on the fast data cache 28 would require a disk access for the write operation, which may interfere with a read command that is to be concurrently performed on the same disk.

According to an embodiment of the invention, the DBIC 22 is configured to cause write blocks to be compressed and stored in a separate RWB cache 40. Preferentially, the RWB cache 40 is formed as a portion 104 of the memory cache 26 to allow the write operations to occur quickly, although the RWB cache 40 can exist as a separate entity, as a portion 106 of the fast disk cache, or both. When the RWB cache is formed as a part of the fast data cache 28, write blocks may be streamed to a dedicated section of the fast disk cache 28, such as to a particular allocated disk 42, to enable the blocks to be written in an accelerated fashion. As the DBIC experiences periods of relatively lower activity, such as during off peak hours, the blocks of data in the caches 26, 28 may be updated using the blocks from the RWB 40, 104, 106. Optionally, the recently written blocks may be merged with the original data using a background job as well to allow the new data to be integrated into the primary locations on the cache.

As write commands are received by the cache manager, the cache manager 48 will update the CAT 36. Where the new block overwrites an old block of data which is of the same size in the memory cache, no CAT update is required. When the write operation results in writing of the block to the RWB cache 40, 104, 106, the cache manager 48 will issue a delete entries operation to the CAT 36 to cause the old entries in the CAT 36 for that data to be invalidated. Deletion of the entries in the CAT 36 allows the DBIC 22 to invalidate data to prevent stale data from being served in response to a read request. Thus, new current data is Attorney Docket No. MP-00301 saved in the same location in the memory cache 26 and doesn't require CAT update if the compressed size of the data will allow it to fit within the memory area allocated for the previous version of the data. Otherwise, the new current data will be written in the RWB cache 40, 104, 106 and an appropriate entry will be made in the CAT 36 to invalidate the old data and cause subsequent read requests for that data to be served from the RWB cache.

In the DBIC 22, the blocks of data associated with write commands may be compressed as discussed above. The compressed data will then be written into the RWB portion of the RAM cache. Where the old data was contained in the RAM cache, optionally, a comparison may be made between the size of the old block of data and the size of the new block of data. Where the new block of data is the same size as the old block of data, the new block is written to the portion of the cache that previously contained the old block rather than to the RWB. Where the new block of data is smaller than the old block of data, the new block may be written to the portion of the cache that previously contained the old block rather than to the RWB portion of the cache, although this wastes some space in the RAM cache. Where the new block of data is larger than the old block of data, since it wouldn't fit into the old section, the new block must be written to a free section of the RAM cache of sufficient size, or if no free sections are available, it is written to the RWB portion of the cache. In this last case, the old section is invalidated, and that cache section is added to a free list of cache blocks.

Since writing a smaller new block into a larger area allocated to the old block will cause a portion of the cache to be unused, a defragmentation process may be run occasionally, in this embodiment, to consolidate unused portions of the cache to make those areas available for storage of additional blocks of data.

To enhance reliability of the DBIC, information may be added to the data stored in the fast disk cache 28 or memory cache 26 to allow the retrieved data to be verified as being related to the data that was requested. For example, as shown in FIG. 8, the data blocks stored in the memory cache 26 and fast disk cache 28 may be provided with a header 120 indicating the LUN 122 and LBN 124 associated with that block of data 126. Optionally, a time stamp 128 may be applied as well to allow the DBIC to determine the age of the block of data 126. The block of data may be compressed, if desired, as discussed above.

By providing the block of data with a header containing the LUN/LBN, the LUN/LBN associated with the data read request may be compared with the LUN/LBN stored in the header to make sure the DBIC has retrieved the proper block of data from the fast disk cache 28 or memory cache 26. Where a CAT corruption or other error occurs and the DBIC retrieves an incorrect block of data, the error may be detected by comparing the requested and returned LUN/LBNs. When an error of this nature is detected, the CAT may be updated to invalidate the data and the read request may be serviced by causing the data to be fetched from another cache in the DBIC, if available, or from the network storage system 18.

Although the invention has been described primarily as operating independently on the storage network 10 or in connection with a storage virtualization unit on the network, the invention is not limited in this manner as the DBIC may be deployed in many different scenarios. For example, the DBIC may be built into the server 12, the network storage system 22, or as a network element such as switch 20 configured to handle data traffic on the network. When implemented as part of the server 12, the DBIC 22 optionally may be implemented to operate in connection with the System Global Area (SGA) of the server to serve pages in response to virtual memory page faults. The invention is thus not limited to use in a particular scenario as it may be used more globally to accelerate database operations regardless of how the database is stored and configured to be accessed by the server.

In the preceding description, the DBIC 22 was described as being configured to perform numerous functions. These functions may be performed by software programs implemented utilizing subroutines and other programming techniques known to those of ordinary skill in the art and configured to run as control logic on a general or specific purpose processor in a computer environment. Alternatively, these functions may be implemented in hardware, firmware, or a combination of hardware, software, and firmware. The invention is thus not limited to a particular implementation.

The control logic described herein, and the functions to be performed using that control logic, may be implemented as a set of program instructions that are stored in a computer readable memory within the network element and executed on a microprocessor. However, in this embodiment as with the previous embodiments, it will be apparent to a skilled artisan that all logic described herein can be embodied using discrete components, integrated circuitry, programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

1. A method for accelerating data access operations in a database system, the method comprising the steps of:
causing at least a first portion of data associated with the database system to be stored in a memory cache;
organizing at least a second portion of the data associated with the database system into an organized manner designed to increase the likelihood that sections of the second portion of data will be able to be retrieved from a disk cache using continuous disk read operations, and causing the at least a second portion of the data to be stored on the disk cache; and
in response to receipt of a read command, reading data associated with the read command from at least one of the memory cache and the fast disk cache if the data associated with the read command is available in the at least one of the memory cache and the fast disk cache.

2. The method of claim 1, wherein the method further comprises the step of pre-fetching a section of the second portion of the data from the disk cache to the memory cache in anticipation of receipt of subsequent read operations.

3. The method of claim 2, further comprising the step of recognizing a pattern of recently received read requests and using the pattern in connection with the step of pre-fetching a section of the second portion of the data.

4. The method of claim 1, wherein the at least a subset of the sections comprise indexes of the database, such that at least a portion of the indexes of the database are able to be retrieved from the disk cache using continuous disk read operations.

5. The method of claim 1, wherein the at least a subset of the sections comprise indexes and table data associated with the indexes, such that at least a portion of the indexes of the database and table data associated with the indexes are able to be retrieved from the disk cache using continuous disk read operations.

6. The method of claim 1, wherein the disk cache comprises a plurality of disk drives, and wherein the disk cache is configured to supplement a capacity of the memory cache.

7. The method of claim 6, wherein the memory cache comprises random access memory.

8. The method of claim 1, further comprising the step of decompressing the data associated with the read command.

9. The method of claim 1, further comprising the step of receiving a read command containing an instruction to provide access to a portion of data associated with the database, and wherein if the data associated with the read command is not available in the at least one of the memory cache and fast disk cache, the method further comprising the step of referring the read command to a network storage system configured to store a complete copy of the database.
